(19) United States
(12) Patent Application Publication
(10) Pub. No.: US 2002/0170037 A1
(43) Pub. Date: Nov. 14, 2002

(54) Apparatus and method for controlling event ordering in a mixed- language simulator

(76) Inventor: Edward W. Powell, Fort Collins, CO (US)

Correspondence Address: HEWLETT-PACKARD COMPANY, Intellectual Property Administration, PO Box 272400, Fort Collins, CO, 80527-2400, US

(21) Appl. No.: 09/798,504

(22) Filed: Mar. 3, 2001

(51) Int. Cl. G06F 9/44

(52) U.S. Cl. 717/131

(57) ABSTRACT

An apparatus and method are provided for controlling event ordering in a mixed-language simulator that utilizes at least one model written in a source code language and at least one model written in a hardware description language (HDL). All event ordering for performing source code model interface tasks is controlled through the use of HDL constructs. The present invention comprises logic that is configured to generate a list of actions to be performed for each occurrence of a trigger event, and to map the list of actions for each trigger event being mapped into a list of objects. The objects are listed in an order that is consistent with the order in which statements appear in the HDL source. The ordering of the objects in the list controls the order of event processing of all source code model interface tasks.

### TECHNICAL FIELD OF THE INVENTION

The present invention relates to a mixed-language simulator and, more particularly, to a method and an apparatus for controlling event ordering in a mixed-language simulator that utilizes models written in different languages to simulate hardware designs.

### BACKGROUND OF THE INVENTION

It is known to mix models of hardware blocks written in the C programming language with models of hardware blocks written in the Verilog® hardware description language (HDL). These models are input to a Verilog® (hereinafter referred to as “Verilog”) simulator program, which performs the hardware simulation. One advantage of using the C programming language to construct some of the modeling blocks, rather than modeling all of the blocks in the Verilog HDL, is that it allows a higher level of abstraction to be used to create the major components of the hardware product being designed. For example, high-level C language descriptions can be written for ICs (Integrated Circuits) and modules within the ICs. These models can then be tied together early in the development cycle to form a complete system-level model. Full system level simulations can then be performed throughout the development of the product, thereby minimizing the potential for discovering system-level defects during the final integration of hardware and software.

Once the higher-level system model has been generated, each hardware block comprising the system model is then progressively refined to lower levels of abstraction by writing the lower-level model portions in the Verilog HDL until the lowest levels of the models, i.e., the gate or transistor levels, have been generated. The mixed-language capability of the simulator allows uneven, parallel development among teams designing different pieces of the project, and provides the flexibility needed to optimize full-system simulation for performance and memory usage.

In a C-to-HDL interface that models a block of code with multiple independent data channels, it is necessary to be able to specify the event processing order separately for each data channel. Many possible syntax constructs can be devised for this purpose, and many different syntax constructs have been used in the past to control event ordering of C model events in a mixed-language simulator. However, techniques that have been used in the past (and that are utilized presently) for controlling event ordering have specified event ordering in the respective C or HDL tasks, rather than only using constructs that are native to the HDL. These techniques make the designer's job of specifying event ordering difficult because they require that the designer have considerable knowledge about the C and HDL models, which increases the difficulty of expressing and controlling the event ordering.

### SUMMARY OF THE INVENTION

Accordingly, a need exists for a method and apparatus for controlling event ordering in a mixed-language simulator that overcomes the aforementioned difficulties. The present invention provides for controlling event ordering in a mixed-language simulator that utilizes at least one model written in a source code language and at least one model written in a hardware description language (HDL). The apparatus of the present invention comprises logic configured to generate a list of actions to be performed for each occurrence of a trigger event, maps the list of actions for each trigger event into a list of objects that are listed in an order that is consistent with an order in which associated HDL objects are listed. The ordering of the HDL objects in the list controls an order of event processing of all source code model interface tasks.

The method of the present invention, which may be performed by a computer program being executed by the apparatus of the present invention, comprises the steps of generating a list of actions to be performed for each occurrence of a trigger event and mapping the list of actions for each trigger event into a list of objects that are listed in an order that is consistent with an order in which trigger events occur such that the ordering of the objects in the list controls an order of event processing of all source code model interface tasks.

These and other features and advantages of the present invention will become apparent from the following description, drawings and claims.

### BRIEF DESCRIPTION OF THE DRAWINGS

FIG. 1 is a block diagram illustrating the manner in which mixed-language model portions are set up and the manner in which they interact with one another in accordance with one embodiment of the present invention.

FIG. 2 is a flow chart illustrating the manner in which the present invention for automatically specifying the configuration of a mixed-language model such that it is specified without redundancy.

FIG. 3 illustrates a unidirectional data flow example to non-redundantly specify the configurations of the models in which the concepts and implementation details represented by the block diagram of FIG. 1 are utilized with mixed-language models.

FIG. 4 illustrates a bi-directional data flow example to non-redundantly specify the configurations of the models in which the concepts and implementation details represented by the block diagram of FIG. 1 are utilized with mixed-language models.

FIG. 5 is an example of an action list data structure illustrating the manner in which event ordering is represented within the C-to-Verilog interface modules of a mixed-language model being simulated.

FIG. 6 is a diagram illustrating an example of an action list created at the beginning of simulation for a dual-channel module example in accordance with the present invention.

FIG. 7 is a diagram illustrating an example of the manner in which events shown in FIG. 6 are mapped into a tree-structured list of Deferred Action objects for simulation.

FIG. 8 is a diagram illustrating a data structure of the interfaced mixed language model objects that enables the indirect specification of event ordering.

### DETAILED DESCRIPTION OF THE INVENTION

The present invention provides for specifying the configuration of models prior to a mixed-language simulation and for performing an event ordering and processing to simulate a hardware design. The term “mixed-language,” as that term is used herein, is intended to denote the mixture of models written in some higher-level source code programming language and models written in a hardware description language (HDL). The present invention is not limited to using any particular higher-level source code programming language or to any particular HDL. However, because Verilog hardware simulators are currently the most widely used simulators, the present invention will be described with respect to using a Verilog simulator and the associated Verilog HDL and Verilog programming language interface (PLI).

Similarly, because the C programming language is currently the most popular source code programming language utilized with Verilog simulators to create mixed-language simulators, the present invention will be described with respect to using this particular programming language with a Verilog simulator and the associated Verilog HDL and PLI.

However, the description of the present invention is only being limited in this way for purposes of brevity and for the purpose of illustrating one particular embodiment of the present invention. Those skilled in the art will understand, in view of the description provided herein, the manner in which other source code programming languages and other simulators, HDLs and PLIs may be utilized to carry out the present invention.

The following references, which are incorporated herein by reference in their entireties, provide information relating to hardware simulation, including mixed-language hardware simulation, and it is believed that they may be useful reference materials for understanding the concepts and implementation details of the present invention: Burgoon, David A., Powell, Edward W., Sorensen, Lief J., Waitz, John A. Sundragon, “Next Generation Concurrent Engineering for Complex Dual-Platform Subsystem Design,” Proceedings of the DesignCon 2000 On-Chip System Design Conference; Burgoon, David A., “Achieving Concurrent Engineering for Complex Subsystem Design: The Case for Hardware Functional Modeling using C,” Proceedings of the DesignCon 1998 On-Chip System Design Conference, pp. 357-371; Burgoon, David A., “A Mixed-Language Simulator for Concurrent Engineering,” Proceedings for the 1998 IVC/VIUF Conference, pp 114-119; Sternheim, Eli Ph.D. interHDL, Inc.; Rajvir Singh, interHDL, Inc.; Yatin Trivedi Y T Associates “Digital Design and Synthesis with Verilog HDL” ISBN 0-9627488-2-x, Copyright 1993 Automata Publishing Company, San Jose, Calif. 95129, and Stroustrup, Bjarne, “C++ Programming Language, Third Edition” ISBN 0-201-88954-4, copyright 1997 by AT&T.

An embodiment of the present invention will now be described with reference to utilization of a Verilog simulator, its associated HDL and PLI, and the C programming language to describe the manner in which the configurations of the models are specified prior to simulation and the manner in which event processing occurs during simulation. Specifying the configurations of the models to be used during simulation is accomplished in accordance with the present invention in a manner that is easy, efficient, and non-redundant. The ordering of events to be processed during simulation is performed in a manner that maximizes simulator performance.

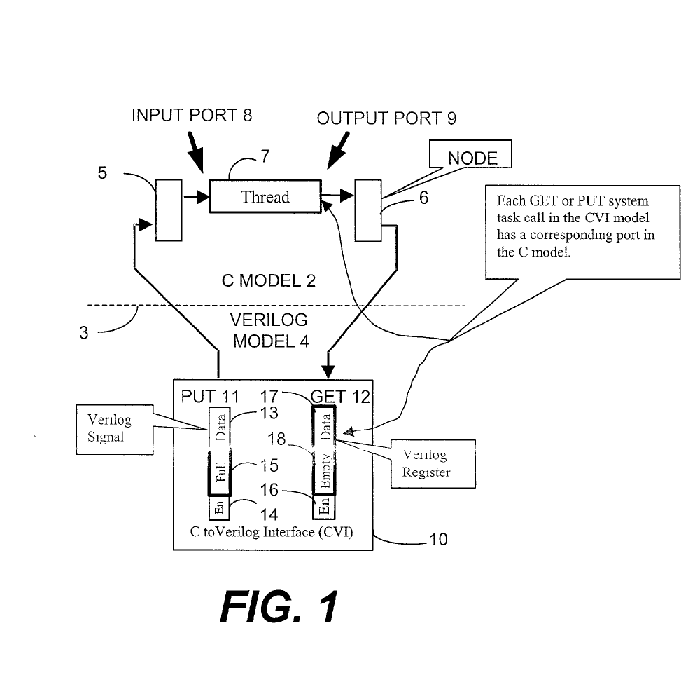

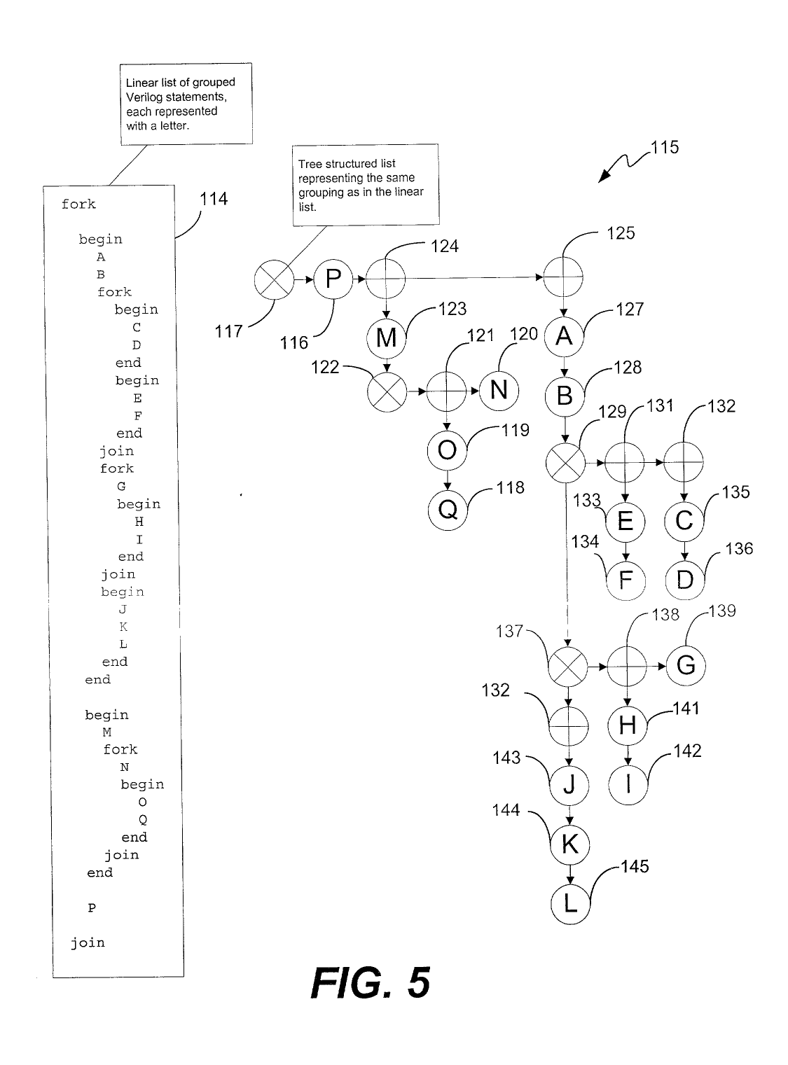

Because the tasks associated with specifying the configurations of the models are performed prior to simulation, the manner in which these tasks are performed will first be described with reference to FIGS. 1-4, and then the manner in which events are ordered and processed during simulation in accordance with the present invention will be described with reference to FIGS. 5-8.

The present invention improves hardware modeling by (1) simplifying the task of writing C models, (2) simplifying the writing of a C-to-Verilog Interface (hereinafter referred to as “CVI”) and (3) improving the performance of the resulting mixed C/V Verilog simulation. Objective (1) is accomplished by providing a new C language application programming interface (API) that makes the C code look more like Verilog code modules. Objective (2) is accomplished by employing a set of Verilog PLI tasks that understand how the C API functions. Objective (3) is accomplished by ordering events in such a way that events are processed efficiently to reduce processing overhead and improve simulator performance.

The version of the PLI utilized in accordance with an example embodiment is Verilog PLI Version 2.0, although other PLI versions, such as Verilog PLI Version 1.0, for example. The Open Verilog International (OVI) PLI functions of both PLI versions have been adopted as part of the Verilog Procedural Interface (VPI) specified in the IEEE 1364 standard. The VPI functions corresponding to PLI Version 2.0 provide a consistent, object-oriented model for accessing all Verilog data structures.

The basic concepts of the present invention will now be described with reference to the block diagram of FIG. 1, which illustrates the manner in which models written in C are interfaced with models written in Verilog. The elements of the portion 2 of a C model to be simulated are above the dashed line 3. The elements of the portion 4 of the Verilog model to be simulated are below the dashed line 3. The C model portion 2 comprises input and output nodes 5 and 6, respectively, thread(s) 7, input ports 8 of the thread(s) 7 and output ports 9 of the thread(s) 7. The C-to-Verilog Interface (CVI) module 10, which interfaces the C model portion 2 with the Verilog portion 4, is written in Verilog.

The CVI module 10 utilizes PUT and GET calls 11 and 12, respectively, and Verilog signals and registers. The Verilog signals of the PUT calls are the “data” signal 13, and the “enable” signal 14. The PUT calls utilize a “full” register 15. The Verilog signal of the GET calls 12 is the “enable” signal 16. The registers of the GET calls 12 are the “data” and “empty” registers, 17 and 18, respectively. The signals of the PUT and GET calls 11 and 12 are objects that are declared as type Wire in the Verilog HDL. The registers of the PUT and GET calls 11 and 12 are declared as type Reg in the Verilog HDL.

The signals 13, 14, and 16 can be viewed as input ports on the CVI module 10 that do not have internal registers declared for them. The values of the signals are fed in to either the PUT or GET calls from outside of the CVI module 10, or are stored locally within the CVI module 10 and fed to the PUT and GET calls. The aforementioned VPI functions that enable the C code to manipulate Verilog objects from within the CVI module 10 only write values into objects that are of type Reg, but can sample the values of both type Reg and type Wire. The PUT call 11 samples the data signal 13 that is the data argument to the PUT call 11 and stores the value that is sampled into the node 5 to which it corresponds. If node 5 becomes full, the PUT task will write a value to the register 15 associated with the PUT call 11 to indicate that the node 5 is full and cannot accept more data. If the enable signal 14 is low, then the PUT action is disabled and, therefore, will not attempt to sample data or send data out to the node 5 when an event occurs that triggers the PUT call. If the enable signal 14 is high when an event occurs that triggers the PUT call, the PUT action will be enabled and data will be sampled and output to the node 5.

With respect to the GET call 12, if the enable signal 16 is high when an event occurs that triggers the GET call 12, the GET call will read data out of the node 6 and write the data to data register 17, which is the data argument of the GET call 12. If the node 6 is empty, the GET call 12 will set a value in the register 18 to indicate that the node 6 was empty. If the enable signal 16 is low when an event occurs that triggers the GET call 12, the GET call will be disabled and will not attempt to read data out of the node 6. The enable signal 16 could be disabled (i.e., low) when, for example, a downstream CVI or Verilog block (not shown) is not ready to receive more data. Both the PUT and GET calls 11 and 12 receive a clock signal (not shown) that triggers them when a specified signal transition edge of the clock occurs.

The CVI module 10 system tasks execute as part of the combined C and Verilog simulation process. In accordance with the present invention, the C model portion 2 represents the functionality of a Verilog module by having one or more “threads” 7. A thread 7 can be thought of as a separate stream of execution that shares memory with other threads in the same process. This allows all of the threads to communicate through a first-in-first-out (FIFO) structure of the nodes 5 and 6. The order of execution of threads 7 can be controlled to execute in a selected order mode, or allowed to run in a random order mode. Utilizing the controlled order mode ensures that simulation results will be repeatable.

The threads 7 have a list of input ports 8 and output ports 9 through which they read and/or write a specific associated node. The thread 7 can write to a node through an output port 9 and read from a node through an input port 8. A port is connected to exactly one node, but a node may connect with multiple thread input/output ports. Thread module “instances” are wired together by associating their ports to nodes. Code modules can also be instantiated into higher-level code modules to form a hierarchy. The nodes associated with the ports of each thread or module instance are unique. For example, if a block containing a node is instantiated more than once in the design, then each block instance contains a distinct copy of that node.

Conceptually, the node represents a collection of wires in a hardware design that conveys information between blocks. As stated above, the node preferably is modeled as a FIFO. The FIFO has a size that preferably is specified at design initialization. The node holds a list of data values that are to be passed between blocks sequentially. Each entry in the node is stored with the same type of C language “struct.” The data in the FIFO can be thought of as the values that would appear on the wires of a design over time. The depth of the node controls how many future data values the C model can calculate before the FIFO full state of the node 6 causes it to suspend. The concept of storing data representing the value of a signal at multiple times will be referred to herein as “temporal buffering”.

A node maintains a list of the threads that read or write to it. Writing to the node corresponds to adding data to the next empty slot in the list. Each reader of the node has a separate read pointer associated with it. A data slot in the FIFO is not considered empty until all readers have read that slot. For an input/output (I/O) port on a C model, the thread that is writing does a read after every write. This is because the I/O port is also listed as a reader of the node. Therefore, if the writing thread did not read back the values, the thread's read pointer would get behind and permanently stall. A thread also reads all data from other threads coming in on an I/O port of a C model before starting to write to the I/O port of the C model. This ensures that the internal state of the thread will be consistent with all past events before the change in write/read direction occurs.

Since different compilers encode data in C structures in different orders, each node has function pointers associated with it that can be used to encode and decode the C structures in a standard byte order. Only nodes attached to ports associated with CVI modules need to define and set encode and decode function pointers. Nodes connected to C model ports associated with CVI modules utilize additional information added to the node when GET and PUT tasks are processed during the simulation initialization. The CVI implementation of the present invention uses separate calls for reading and writing nodes that pass in information about which CVI instance is performing the read or write operation. The CVI read and write operations exchange data only with the set of threads associated with the CVI instance.

There preferably are four CVI system tasks that are utilized by the present invention, namely, $gps_get_fm_c ( ), $gps_put_to_c ( ), $gps_pull_fm_c ( ), and $gps_push_to_c ( ). These system tasks are only used in the Verilog initial block of a CVI module 10. Each call to a system task is associated with exactly one port on the C model. The port handle argument along with the Verilog instance path of the calling CVI module is used to uniquely identify the corresponding C port instance. A given C model port has only one input type CVI function and one output type CVI function associated with it.

The C model API of the present invention includes C model tools that form a new C model API having a corresponding set of API rules. A C model API library preferably is built around two basic concepts, namely, modules and nodes. The C model API modules are used to mimic the hierarchical nature of a hardware design and are intended to map one-to-one to the top-level modules in the corresponding Verilog model portions of the design. The syntax for a C model API module preferably looks similar to that of Verilog and preferably Verilog module templates are created from C by running a translator that exports the C model hierarchy in the form of a Verilog netlist. There are two types of C model API modules, namely, blocks and threads. Blocks only call other blocks and/or threads, and thus have no behavioral code associated with them. They are essentially like a Verilog module containing only instantiations of other modules. A thread is a leaf module that models behavior and only calls C model API library functions and standard C functions.

A C model API module preferably has only one argument, namely, a pointer to a user-defined structure. The user-defined structure preferably includes a list of three predefined types, namely, gps_input, gps_output, and gps_inout, and constants, which preferably are of type int. All data comes into or leaves a C model API module through the ports defined in the argument. Thus, a standard (thread) C model API module declaration might look as follows:

| gps_struct(mfu) | | // the struct name (mfu) must match a module name |
|---|---|---|
| | { | |
| | gps_input | reset; |
| | gps_output | busy; |
| | gps_input | fifo_in; |
| | gps_output | fifo_out; |
| | gps_inout | readback_bus; |
| | int | mfu_reg; // local info register |

gps_module_thread(mfu,myptr)
// (modulename,reference_pointer_to_struct)

| { | |
|---|---|
| // assume there are 3 mfu's in this design so they each need a | |
| // separate set of registers | |
| int data; | // this is a procedure local so it disappears each |
| | // pass thru the thread |

gps_read_or suspend(myptr->fifo_in,&data)
if (something)

myptr->mfu_reg = data;

else

gps_write_or_suspend(myptr->fifo_out,&data);

}

The nodes of the C model API of the present invention greatly simplify the creation of the CVI modules. All communication between C model API modules is accomplished through nodes. Thus, a port of one C model API module is connected to a node, which is then connected to one or more ports of other C model API modules. A node is equivalent to a bus or wire in Verilog. In C, a node essentially allows time to be separated between modules that mimic parallel execution, but that, in reality, execute one at a time (i.e., on a uniprocessor, or in repeatable simulation mode). A node does not communicate with another node, but rather, it communicates with a thread module containing reads or writes on one of the module ports. Thus, only one node is allowed on any one “net,” or set of connections to modules. It is up to the designer to determine where in the hierarchy the node is actually declared. Nodes are most easily created in a calling block, but can be created inside a called block, as discussed below in more detail. The example below demonstrates this.

A node may be created by declaring its name and then calling gps_inst_node ( ) with its depth and width. To ensure good performance, it has been determined that a depth declared to be 64 or greater is suitable, and that only power of 2 depths should be allowed. By programming a node to a depth of 1, tight coupling between threads can be obtained. This is useful for signals such as, for example, “reset” (which typically has multiple readers), where it is undesirable for threads to proceed until all threads have been reset.

As stated above, nodes preferably can have multiple readers and multiple writers. If there are multiple readers, each reader advances at its own rate. The slowest reader determines the “used” count (the number of occupied node entries) for all writers. With multiple writers, it is up to the programmer to control which thread may write to a node next, in order to keep the write data in the proper order. Writes can be forced to occur, even if the node is full, by using the argument gps_write_over ( ), as opposed to what is referred to herein as the standard gps_write_or suspend ( ) argument. In accordance with the preferred embodiment, the ability to read without the possibility of suspending is provided by checking the node “used” count (i.e., using gps_used ( ) or gps_empty( )) before issuing the read (i.e., before using the gps_read_or suspend ( )).

A port on a module may be declared gps_inout. When this is the case, the programmer or designer should ensure that a node is always read to an empty condition before writing the node. In addition, every write should be accompanied by a “dummy” read to insure that the read pointer for the writing thread does not get behind. Nodes preferably have data-in-flight between threads. When modeling signals such as “busy” or “WPNE” (write pipe not empty) that indicate unprocessed data, the receiving block cannot indicate a busy condition because it has not read the data yet. To solve this problem, the node write functions preferably allow a secondary node to be written, as a side effect of writing the primary node. This is accomplished by attaching one or more “busy” nodes to an instantiated node. Whenever the node is written, a “1” will also be written to the attached “busy” nodes, which can only have a data width of “int.” “Busy” nodes preferably will generally have a depth of 1 and are written in overwrite mode since only the latest value is important. “Reset” nodes also preferably have a depth of 1 to insure that all blocks have read the reset value before a new value can be written.

Locks (i.e., gps_node_lock_or_suspend ( ) and gps_unlock ( )) are used to prevent another thread from changing the state of a node that needs to be frozen. This is necessary on “busy” nodes where one thread is attempting to clear the “busy” signal, while another thread is trying to set the “busy” signal as a side effect of writing an input to the first thread. Thus, locks allow a thread to safely change an output by blocking other threads from performing operations that may affect the output. One or more “reset” nodes may also be attached to a node. When an attached “reset” is “1”, the node will reset all internal pointers to zero. Attached “reset” nodes may only have a width of “int.” The C model API creates a special thread that goes through all the attached “reset” nodes looking for an active reset data value. When it finds one, it forces each node into a reset state until the reset condition is cleared.

Below is an example of the manner in which nodes can be created and hooked up or connected to modules. It should be noted that the identifier “chip” corresponds to a block module and “mfu” corresponds to a thread module.

gps_struct (chip)

| | |
|---|---|
| { | |
| gps_input | reset; |
| gps_input | in_bus; |
| gps_output | out_bus; |
| }; | |

gps_module_block(chip,chipports)
{

| gps_decl_node(mfu0to1); | // declare node | |
|---|---|---|
| gps_decl_node(in_bus); | // input node is declared inside chip ! | |
| gps_decl_node(busy0); | // busy for mfu0 | |
| gps_node busy1; | // busy for mfu1 - | |
| | // another way to do the same thing | |
| gps_decl_inst(mfu,mfu_0); | | // declare one instance of mfu |
| gps_decl_inst(mfu,mfu_1); | | // declare another instance |
| | | of mfu |
| unsigned int | bus; | // bus is 32 bits |

| // end of declarations - start executable code | |
|---|---|
| gps_inst_node(busy0,1,sizeof(int)); | // create busy node |
| gps_inst_node(busy1,1,sizeof(int)); | // create busy node |

gps_inst_node(chipports->in_bus,64,sizeof(bus));// create input
node

| | |
|---|---|
| gps_node_busy(mfu0to1,busy0); | // attach busy to node |

gps_inst_node(mfu0to1,64,sizeof(bus));// create node depth=64

| gps_node_rset(mfu0to1,port->reset);// attach reset to node | |
|---|---|
| gps_node_busy(mfu0to1,busy1) | // attach busy to node |

// instantiate and wire up mfu_0
gps_inst_module(mfu_0);

| | |
|---|---|
| gps_port(mfu_0->reset | ,chipports->reset); |
| gps_port(mfu_0->fifoin | ,chipports->in_bus); |
| gps_port(mfu_0->fifoout | ,mfu0to1); |
| gps_port(mfu_0->busy | ,busy0); |
| gps_cnst(mfu_0->mfu_id | ,0); |
| gps_end ( ); | |

// instantiate and wire up mfu_1
gps_inst_module(mfu_1);

| | |
|---|---|
| gps_port(mfu_1->reset | ,chipports->reset); |
| gps_port(mfu_1->fifoin | ,mfu0to1); |
| gps_port(mfu_1->fifoout | ,chipports->out_bus); |
| gps_port(mfu_1->busy | ,busy1); |
| gps_cnst(mfu_1->mfu_id | ,1); |
| gps_end( ); | |

}

It should also be noted that the node for in_bus on chip is declared inside the module instead of at the next higher level in the hierarchy. This allows programmers or designers who prefer to embed the node into a block to do so since it is modeling a FIFO present in that block. Because no node exists in the higher level, when chip is instantiated, the port name is used twice in the gps_port hookup call as shown below:

gps_inst_module(chip_instance);

gps_port(chip_instance−>in_bus, chip_instance−>in_bus);

Preferably, all C model API exposed defines, variables, typedefs, structures, and function calls are contained in the file gps_hwsim.h. Most functions preferably are macros that invoke one or more functions. The entire C model API, in accordance with the preferred embodiment, is described by the following:

declaration macros:

| | |
|---|---|
| gps_struct(ModuleName) | - used to declare a module structure |
| gps_module_block(ModuleName) | - used to declare block (hierarchy) |
| modules | |
| gps_module_thread(ModuleName) | - used to declare thread (leaf) modules |
| gps_decl_inst(ModuleName,InstanceName) | |
| | - used to declare an instance of a module |
| gps_decl_node(NodeName) | - used to declare a node |
| typedefs: | |

| | |
|---|---|
| gps_node | - alternate way to declare nodes |
| gps_input | - used to declare an input port in the gps_struct |
| gps_output | - used to declare an output port in the gps_struct |
| gps_inout | - used to declare an bi-directional port in the gps_struct |

module instantiation macros:

| | |
|---|---|
| gps_inst_module(InstanceName) | - instantiate a module |
| gps_port(PortName,Nodename) | - hook up module port |
| gps_cnst(PortName,Value) | - hook up module constant port |
| gps_end() | - end instantiate |

node instantiation macros:

| | |
|---|---|
| gps_inst_node(NodeName,Depth,Width) | - instantiate a node |
| gps_node_rset(NodeName,ResetNodeOrPort) | - attach a reset to node |
| gps_node_busy(NodeName,BusyNodeOrPort) | - attach a busy to node |
| node macros: | |

| | |
|---|---|
| gps_free(PortName) | - returns int (free == 0) means full |
| gps_used(PortName) | - returns int (used == 0) means empty |
| gps_empty(PortName) | - returns TRUE/FALSE |
| gps_full(PortName) | - returns TRUE/FALSE |

| | |
|---|---|
| gps_write_or_suspend(PortName,&Data) | - normal write |
| gps_write_over(PortName,&Data) | - trash last empty if full |
| gps_read_or_suspend(PortName,&Data) | - normal read |
| gps_peek_or_suspend(PortName,&Data) | - get data but don't advance node |
| gps_io_read_or_suspend(PortName,&Data) | - for input/output nodes |
| gps_read_if_not empty(PortName,&Data) | - reads one entry if not empty |
| gps_read_until_empty(PortName,&Data) | - read until empty (no suspend) |
| miscellaneous functions: | |

| | |
|---|---|
| gps_suspend() | - suspend the current thread (nothing else to do) |

gps_node_lock_or_suspend(PortName)

| | |
|---|---|
| | - lock thread ports (used for busy determination) |
| gps_unlock() | - unlock all locked thread ports |
| gps_force_thread_active() | - the thread is considered active even if no ops |
| completed | |

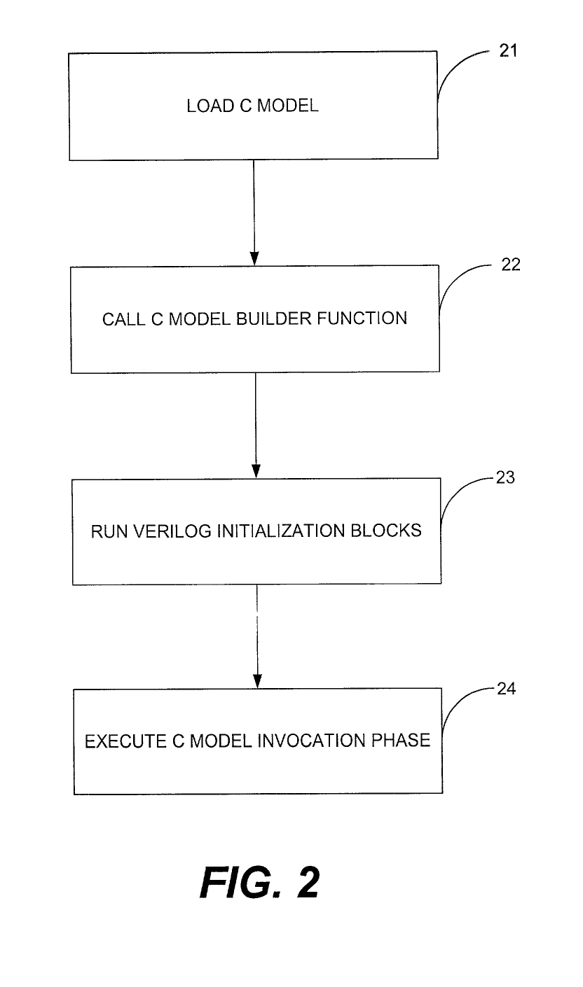

The manner in which a mixed-language simulator is initialized in accordance with the preferred embodiment of the present invention will now be described. One of the primary features of the present invention that enables non-redundant specification of the configuration of the mixed-language model is that, inside the initial blocks of the Verilog model, tasks are called that analyze the hierarchy path within the Verilog model and identify the corresponding hierarchy path in the C model. These tasks mark flags within the C model that inform the C model of which connections within the C model are to be enabled or disabled. The specific way in which these functions are accomplished in accordance with the preferred embodiment will now be described with reference to the flow chart of FIG. 2.

The first step in specifying the configuration is to dynamically load the project-specific portion of the C model into the simulator, as indicated by block 21 in the flow chart. When the C model is loaded, C code contained within a shared library is loaded into the executable image of the simulation process by the operating system dynamic loader. This is accomplished through use of a VPI callback triggered at the beginning of the Verilog initialization sequence, or, in the case of a stand-alone C model, on startup of the stand-alone C model simulation. The phrase “stand-alone C simulation” is intended to denote herein simulation of a hardware design in which the code models utilized by the simulator to perform the simulation are all written in the C programming language (i.e., no models are written in an HDL).

The shared library comprises functions defined in the C language that will be used by the simulator during simulation. An argument is defined to specify the shared library name for the C model to be loaded. Function naming rules are defined to help avoid namespace collisions of C model functions with simulator functions.

Once the C model has been loaded, a C model builder function is called to build the C model hierarchy, as indicated by block 22. During the initialization phase of startup, the C model threads and nodes are instantiated in order to build the C model hierarchy. The C model may have run-time configurable options that control how the C model is built. In this case, these options can be specified through command line arguments that allow the user to specify name=value pairs in a namespace specific to the C model. If a variable name is not found in the C model namespace, then the Verilog variable definition namespace will be searched. In the case of a stand-alone C simulator, a “Verilog Namespace” will be created in the stand-alone C simulator by placing values set with Verilog style command line arguments into the Verilog namespace.

A scope resolution syntax preferably is provided to allow the C model author to restrict the resolution of a variable to only the C or Verilog namespace. The syntax of the variable definition arguments for the stand-alone C simulator is kept the same as that used for the Verilog simulator. The stand-alone C simulator will also provide a mechanism, similar to the Verilog “-f” argument, for reading arguments from a file. This simplifies writing of the “makefile” used to invoke the simulator. The same code for accessing the C model namespace can be used in the stand-alone C simulator and in the Verilog simulator. The configuration of the design is specified in a file that is interpreted in conjunction with the makefile to produce a list of invocation arguments for the simulator, including C model variable definitions, Verilog defines, include directories, and specific files to be loaded or compiled. It should be noted that variables defined in the Verilog namespace can be used to control selection of hierarchy options in both the C and Verilog portions of the model.

After the C model has been built, the Verilog “initialization” (initial) blocks are executed, as indicated by block 23 in the flow chart. Inside of these blocks, calls are made to the GET and PUT tasks. Each GET and PUT call knows where it was called from in the Verilog model hierarchy. These calls use their respective hierarchy paths in the Verilog model to find the corresponding hierarchy paths in the C model. When these calls find the ports of the corresponding paths in the C model, they cause the respective ports in the C model to be tagged to indicate that the ports have corresponding GET and PUT calls in the Verilog CVI module. From this tagging process, the C model can determine which ports are active in the C model and which are not. Ports in the C model that are inactive correspond to portions of the C model that are to be simulated with the Verilog model. Ports in the C model that are active correspond to portions of the mixed-language model that will be simulated with the C model portions and the resulting signals will be processed and interfaced to the Verilog model portions by the CVI modules 10.

The CVI modules 10 are responsible for “self-configuring” the connections between threads when invoking in a mixed C and Verilog simulation. Thus, duplication, or redundancy, is avoided when specifying if models are to use Verilog or C. The CVI modules 10 corresponding to any blocks that are to be modeled in C are simply loaded into the Verilog simulator, and the CVI modules 10 then automatically activate the appropriate connections. Therefore, no C model language specific arguments are needed to control model mode.

A “Port_CVI_mode” and “Node_CVI_mode” flag exist for each of the ports and nodes of the C model. In the case of a stand-alone C model simulator, when the C model is invoked in stand-alone mode, all of the Port_CVI_mode flags are initialized to “false,” and all of the C model threads are therefore active. When a mixed C and Verilog simulation is started, all of the port CVI mode flags are initialized to “true”. When the CVI GET and PUT tasks are called from the initial blocks of the CVI modules, the flag on the corresponding port, and any hierarchical ports at higher levels, will be set to “false”. The C model then uses the flag settings to determine which connections are to be left active. A C model with all CVI_mode flags on its ports set to “true” is deactivated because the functionality of that model portion is to be simulated in Verilog. A C model with all of the Port_CVI_mode flags set to “false” is assumed to be active, either because a CVI module is present or because the stand-alone C simulation was started. If some of the Port_CVI_mode flags are set to “true” and some are set to “false” on a primitive CVI instance, an error is reported indicating that the CVI module has not handled all the ports of the corresponding C model.

At the end of the Verilog initialization sequence, a C model invocation phase occurs, as indicated by block 24. During this phase, a routine is called to determine which C models are active and, if so, which of its ports that correspond to CVI module ports are active. This is needed to optimize simulation performance by eliminating node connections and VPI callback events that are not needed. The routine determines whether C model ports that are associated with CVI ports are active by checking the readers and writers of each node in the C model. Any node that has reader or writer ports with the Port_CVI_mode flag set to “true” gets flagged as Node_CVI_mode “true.” CVI module ports connected to nodes in the C model that have their Node_CVI_mode flags set to “true” are enabled by the routine. Enablement of a CVI mode node can be thought of as allowing the values of data modeled in C nodes to be read from or written to the corresponding Verilog signals. For special case situations, a node can be forced to be active by preceding the port name with ‘F:’ in the CVI system task first argument. This is used only when it is desired to force a node's data to be copied to Verilog, even if the node connects only between two CVI modules.

The aforementioned $gps_get_fm_c ( ), $gps_put_to_c ( ), and $gps_push_to_c ( ) CVI system tasks are also responsible for setting up callbacks that are activated when a user-specified Verilog event occurs, such as a clock edge or value change. For a given trigger event, a list of callback actions to be performed is created in the CVI module. The order in which the actions are performed is determined by the order in which the calls appear in the CVI module. For each call, a list of previously defined callback events is searched, and, if found, a callback action is added to the list for that event. If a callback event is not found on the list, a new callback action list is created. Each callback action includes information about the corresponding C model port and the Verilog signals associated with it.

The CVI modules 10 must ensure that the data in the Verilog registers is formatted consistently, independent of machine architecture and compiler. To accomplish this, CVI code performs checks to determine if a node has an associated “encode/decode” function pointer that is set. If it does, then this function is used to reorder the bytes returned from or written to the C model into a standard, machine-independent order. A default “encode/decode” function that handles integer data preferably is provided in the thread library. For other data types, the author of the C model must set a model-specific “encode/decode” function for all nodes that may connect to CVI modules of the Verilog model.

The read and write operations on nodes that are in CVI mode differ from those of nodes that are in C-only mode. An example node structure for a CVI mode node is shown below in Table 1.

TABLE 1
CVI mode node structure

| | | | | | | | | | | | | |
|---|---|---|---|---|---|---|---|---|---|---|---|---|
| C2V | Src | Dest | Data | WP | RP | RP | RP | RP | RP | RP | RP | RP |
| subnode | ID | ID | | | T1 | T2 | T3 | T4 | T5 | C1 | C2 | Lag |
| V2C | Data | WP | RP | RP | RP | | | | | | | |
| subnode | C1 | | T1 | T2 | Lag | | | | | | | |
| V2C | Data | WP | RP | RP | RP | RP | | | | | | |
| subnode | C2 | | T3 | T4 | T5 | Lag | | | | | | |

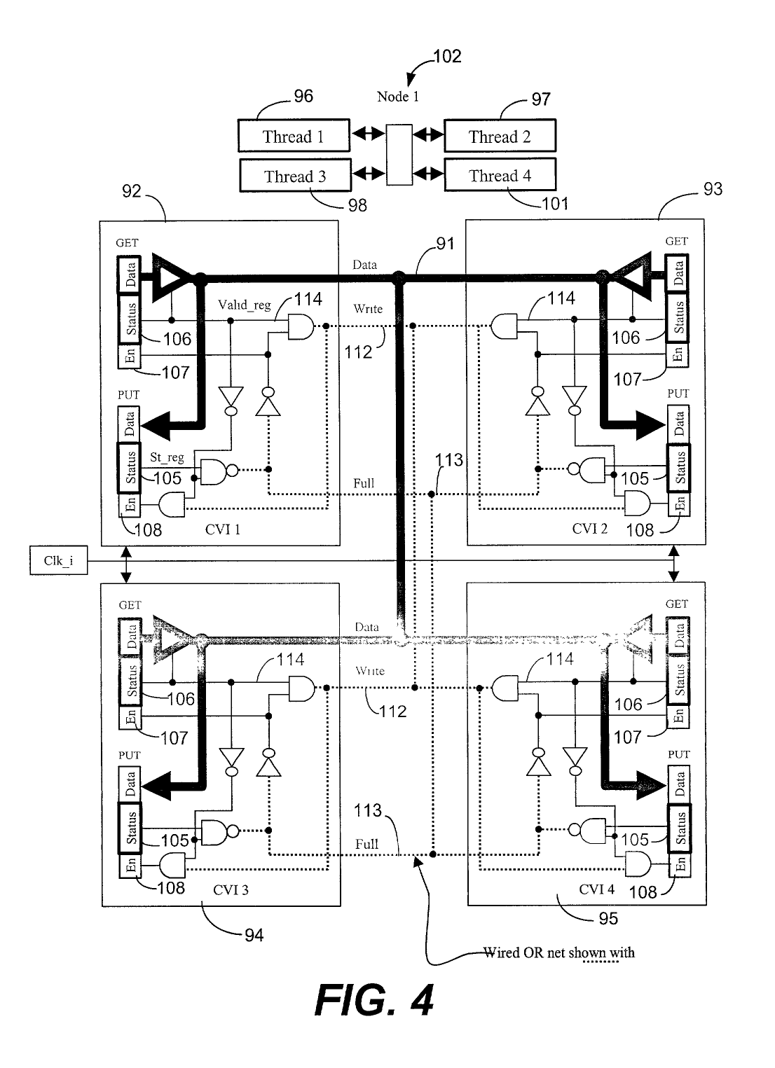

When a node is in CVI_mode, its depth is reduced to 2 if it was greater than 2. The SrcID and DestID values shown in the table are used to insure that data is addressed so that the CVI routines communicate only with their corresponding threads. The DestID value is also used to inform the CVI module that a write of NULL data occurred. A NULL data write by the C model results in the status register being set low, and the Verilog signal being set to high-Z. The source and destination checking makes it possible for the CVI modules of the Verilog model to support bi-directional connections, with multiple readers and writers. A bi-directional example is discussed below with reference to FIG. 4.

An optional status register value can also be used as the tri-state control signal in the CVI modules of the Verilog model. Blank boxes in Table 1 represent data storage locations. When a node is converted to CVI mode, it has a V2C (Verilog-to-C) subnode created for each CVI writer of the node. Each CVI instance that reads the node is registered in a C2V (C-to-Verilog) subnode read pointer list. In the C2V and V2C sections of the node, a lagging read pointer indicates the oldest unread data slot. Each thread that reads the node is registered in the C2V subnode, and in the V2C subnode for the CVI instance to which the thread corresponds.

CVI read or write operations pass in an inst ID value as an argument. The inst ID value is used to find the correct read pointer in the C2V subnode for a read, and the correct V2C subnode to which to write. The CVI read calls always read from the C2V portion of the node. The CVI write calls always write to the V2C portion of the node. The V2C subnode always has a depth of 1. The V2C data value holds the last data sampled from Verilog. A read pointer for each C model corresponding to a CVI instance is allocated in the V2C subnode. This read pointer indicates whether the corresponding C model has read the data in the V2C subnode.

When a C model portion writes a CVI mode node, it sets the C2V write pointer (WP). When a C model thread reads a CVI mode node, it advances its corresponding read pointer (RP) in the V2C subnode. If the C2V read pointer indicates unread data for that thread, then the C2V read pointer is also advanced. The C2V pointer may be empty in the case where the data in the V2C subnode came from a Verilog model driving the net associated with this node.

As stated above, the Verilog signal arguments may be wire or register type Verilog objects. Any arbitrary set of signals can be combined by declaring a wire object with an assign expression containing a concatenation of signals. The resulting list of bits in CVI Data_sig or Data_reg arguments to the GET and PUT tasks must correctly map to the fixed byte order defined by the encode/decode function of the C model port's associated node. It is up to the CVI module author to correctly map the generic signals associated with the GET and PUT tasks to the specific signals and protocol of the Verilog model portion that is being modeled. A CVI module may use as many GET and PUT calls as needed. All of the callback actions will be grouped by trigger event, and the actions for a given trigger event will be executed in the order in which the system tasks appear in the CVI module's initial block. Actions that are blocked at a given trigger event may prevent other actions for the same trigger event in the CVI module from completing. The CVI system tasks are as follows:

$gps_put_to_c(Port_handle, En_sig, Timing_control, Full_reg, Data_sig, Status_reg)

$gps_get_fm_c(Port_handle, En_sig, Timing_control, Empty_reg, Data_reg, Status_reg)

$gps_push_to_c(Port handle, Data_sig)

$gps_pull_fm_c(Port_handle, Data_reg, Delay_spec, Delay_reg)

Port_handle—String name of the corresponding port in the C model.

Preceed Port_handle string with “F:” to force port to be in Verilog mode.

En_sig—Verilog signal indicating that operation is enabled, or “1” to always enable

Timing_control—Callback action event control of the form “@(edge_event_expression)”

Empty_reg—Verilog register to store the node empty flag, or “0” for never empty

Full_reg—Verilog register to store the node full flag, or “0” for never full

Data_reg—Verilog register variable in which to write data read from C

Data_sig—Verilog signal containing data to be written to C

Delay_spec—Optional delay time when processing Verilog signal change, default is 0

Delay_reg—Optional Verilog signal in which to write delayed version of pull signal

Status_reg—Optional Verilog register variable to store action completion status.

A bi-directional port is modeled by using both the $gps_get_fm_c ( ) calls and $gps_put_to_c ( ) calls with the same Port_handle. This works because all port connections to the C model node are really bi-directional. A read from a port pops the oldest value from the FIFO of the connected node, and a write adds a new youngest entry to the FIFO of the node. By using the signals from both system calls, in combination with a tri-state assign statement in the CVI module, a wide variety of bi-directional signal protocols can be modeled. An example of a system with bi-directional signals is provided below in detail with reference to FIG. 4.

The $gps_push_to_c ( ) system function is used to model asynchronous signals. Whenever Data_sig changes, the new value is written in “Write Over” mode to the node associated with Port_handle. The $gps_pull_fm_c ( ) system function is also used to model asynchronous signals. Whenever a new value is written to the node associated with Port_handle, the Data_reg value is updated.

A delay feature is used to control the timing of power-on reset nodes. If Delay_spec is defined, then a second reader is defined, and this read occurs after the specified delay. If Delay_reg is specified, then it is set to the value read using the Delay_spec in a TransportDelay mode. In any of the CVI system task calls, an “F:” can be included at the beginning of the Port_handle string to force a specified port to be active, even if the port is only connected to other CVI ports. This call has the effect of setting the port's associated node to be in CVI mode.

When building a CVI module of the Verilog model, inclusion of system task calls in procedural blocks is not necessary. Preferably, all actions to be taken during the simulation are setup as callbacks by the CVI system tasks in the initial block. One of the main reasons for designing a CVI module in this way is to provide compatibility with cycle-based simulation. However, procedural blocks can be used in CVI modules if needed, provided they are cycle based simulation compatible. Generally, this means that they must follow the synthesis subset, and they cannot call any system tasks, or rely on Verilog #delay values.

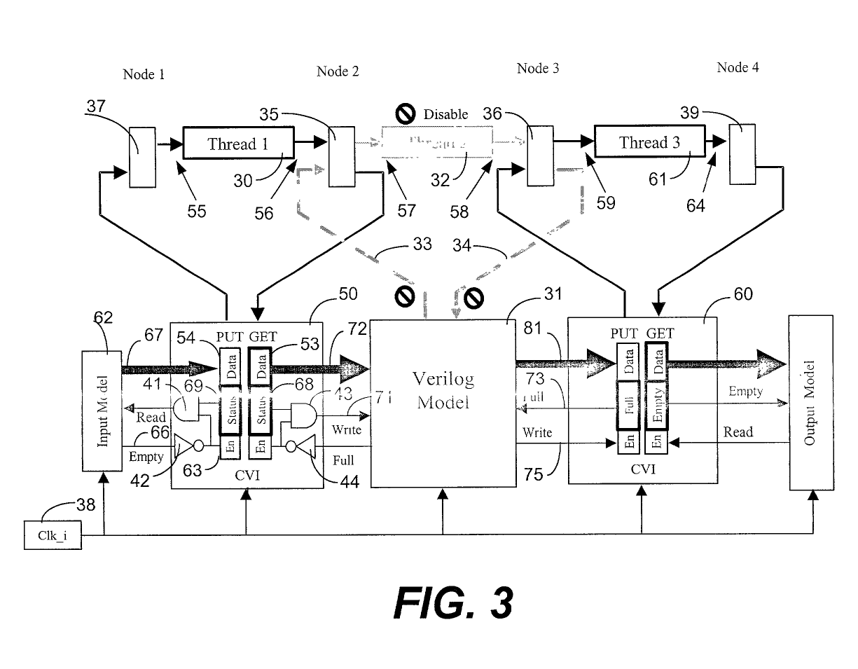

In order to illustrate the use of the CVI modules, a unidirectional example will now be provided with reference to FIG. 3 in order to provide an understanding of the flow of data between the CVI modules and the Verilog and C model portions. The example shown in FIG. 3 demonstrates several different types of unidirectional FIFO interfaces. Since the model 31 corresponding to thread 2 is a Verilog model, thread 2 and its associated connections 33 and 34 to node 2 and node 3 labeled with numerals 35 and 36, respectively, are shown with dashed lines to indicate that they are disabled. The trigger event in this system is @ (posedge Clk_i), or in other words, the positive edge of clock signal Clk_i, which is labeled with numeral 38. By using Verilog modeling code in the CVI module to connect external control signals to the GET and PUT system tasks, a wide variety of inter-module signaling protocols can be supported.

The Verilog code for the CVI module 50 in this example could look as follows:

Module block1 (Clk_i, Dout, Din, Empty, Read, Write, Full);
input Clk_i, Empty, Full;
output Write, Read;
input [3:0] Din;
output [3:0] Dout;
reg [7:0] data_reg;
reg valid_reg, st_reg;
wire NotEmpty = ˜Empty;
wire Notfull = ˜Full;
assign Dout = {data_reg[7],data_reg[5:4],data_reg[0]};
assign Write = (valid_reg & ! Full);
assign Read = (st_reg & ! Empty);
wire [5:0] put_din = {Din[3],1′b0,Din[2:1],3′b0,Din[0]};
initial begin

$gps_put_to_c(“Din”, NotEmpty, “@(posedge Clk_i)”, 0,
put_din, st_reg);
$gps_get_fm_c(“Dout”, NotFull, “@(posedge Clk_i)”, 0,
data_reg, valid_reg);

end
endmodule

The assign statement expressions in the Verilog code for the CVI modules correspond to the “AND” and “INV” gates 41, 42, 43, and 44.

The use of a concatenation in the above assign statement should be noted. This associates the bits of the output port Dout of the CVI module 50, which corresponds to arrow 72, to specific bits of data_reg 53. This is also where the CVI module author associates the bits written into data_reg 53 to the actual Verilog signals to which they correspond. Similarly, the data_sig argument 54 of the PUT system task (put_din) uses a concatenation to encode the incoming Verilog signals 67 into specific bits. The bit order in data_reg 53 and of data_sig 54 does not need to change with machine architecture because of the use of the aforementioned encode and decode functions.

The arrows 55, 56, 57, 58, 59, and 64 shown in FIG. 3 connecting to nodes 37, 35, 36, and 39 represent calls to read or write a port that is connected to the corresponding node. As in FIG. 1, in this example, the variables represented by blocks shown in bold in the CVI modules correspond to Verilog registers. The C model portions of the mixed-language model to be simulated are represented by the nodes 37, 35, 36, and 39 and by threads 30, 32, and 61. In the case of a stand-alone C model simulation, the CVI modules 50 and 60 and the Verilog model 31 would not be needed. However, for mixed-language simulation, CVI modules are instantiated for the portions of the mixed-language model that are to be simulated in C, and Verilog model portions are instantiated for the blocks that are to be simulated in Verilog.

As discussed above with reference to FIG. 2, during initialization, the GET and PUT tasks of the CVI modules 50 and 60 set flags on the nodes and the ports of the corresponding threads that the simulator uses during initialization to determine which connections need to be activated. The Verilog model 31 does not have any GET or PUT task calls, so the CVI_mode flags corresponding to ports associated with the second thread 32 are not modified from their initial value. This results in disablement of the second thread 32, and the lines 33 and 34 associated with the Verilog model 31 are dashed to indicate this. The C model has readers and writers that can be registered for the GET and PUT tasks that are in the CVI modules. If those readers and writers are not registered, the C model is able to determine that there is no data flowing from the Verilog model 31 into the second node 35 or out of the third node 36 associated with the second thread 32. Therefore, the simulator is able to determine that the second thread 32 does not ever need to be invoked as an executing thread.

Therefore, instead of the second thread 32 reading data out of the second node 35, the trigger action clock signal 38 causes the GET action of CVI module 50 to be activated, which causes the data to be read out of the second node 35 and stored in register 53 as a Verilog data signal. Each time the clock signal 38 occurs, the input model Verilog block 62 drives an empty signal 66 out and a data signal 67 out in the Verilog portion of the simulation. As the clock signal occurs, the enable signal 63 of the PUT call is set so that the PUT call knows that it is supposed to sample data on some particular clock edge when the input model 62 determined there was data. Thus, when the empty signal 66 goes low, the enable signal 63 goes high, thereby causing the PUT call to sample the data signal 67 coming in from the input model 62 into the CVI module 50 when the value in the status register 69 of the PUT call is high. This causes the PUT call to write the data signal 54 via an encode function into the first node 37.

Then, in the evaluation phase, a deferred action handler will schedule the first thread 30 to have some time to execute and then thread 30 will read out of the first node 37 the data that got written to it by the PUT call. The thread 30 will then process this data and write the results of this processing into the second node 35. Meanwhile, the GET call of CVI module 50 was triggered on the same clock edge that triggered the PUT call. Therefore, the GET call will continue attempting to read data out of the second node 35 until data is present in the second node 35, or until an iteration limit condition occurs indicating that the C model is stable. The data read out of node 35 is written into the data register 53 associated with the GET call, and then is driven out of the CVI module 50 as a Verilog signal 72 on the next clock signal.

The value of the status register 68 of CVI module 50 becomes “true” if the GET call successfully obtained data from the second node 35, which causes the write signal 71 to go high. On the next clock cycle, the Verilog model 31 will sample the write signal 71 and determine that it is high, and will therefore sample the data 72 from the data register 53 coming into the Verilog model 31. The Verilog model 31 will process the new data and, some number of clock cycles later, will set its write signal 75. Verilog model 31 will maintain the data value as long as the full signal 73 of CVI module 60 is high. Then, on some later clock cycle, the CVI module 60 will set the full signal 73 low. This occurs as the third thread 61 reads data from the node 36, thus freeing up a slot in which to write data into the third node 36. On a cycle when the node full flag has been set low (signal 73), and the write enable input signal 75 is high, the PUT task in CVI module 60 will sample the data 81 coming out of the Verilog model 31. The CVI module 60 PUT task will then write the data to the third node 36 of the third thread 61 and the process will continue in the manner described above with reference to the CVI module 50.

The example shown in FIG. 4 illustrates the manner in which the CVI system tasks are used to model a multipoint, bi-directional bus 91. The bus protocol is assumed to include, in the data bits of the bus 91, information that determines which of the CVI modules 92, 93, 94, or 95 will be allowed to write on the next cycle. For simplicity, no Verilog model portions are shown in FIG. 4, although they are presumed to exist. Also, all of the CVI modules that are not writing data are assumed to be reading data, and determining if the data word is to be used by them. The focus of this example is to illustrate how multiple readers and writers of a node are managed, rather than a specific bus protocol or addressing mechanism.

Each of the CVI modules 92-95 has a corresponding thread associated with it. The first, second, third and fourth threads are labeled with the numerals 96, 97, 98, and 101, respectively. Node 102 represents the data on the bus 91. Each of the threads has a bi-directional arrow connecting its port to the node 102. This is meant to indicate that each thread can read and write the ports associated with the node 102. Whenever a thread writes to a bi-directional node, the following procedures are followed:

Read and process all current data in the pipe. This ensures that the internal state of the thread is “caught up” with the current time, before doing a write.

Write data to the node, and immediately read back the data that was just written to ensure that the read pointer does not get behind and cause a hang. This is necessary because the writing thread is also listed as a reader of the node.

The source and destination thread ID stored with the data in the CVI mode node, and the CVI subnode structure are particularly important for the bi-directional case represented by FIG. 4. It should be noted that multiple CVI modules with the same trigger event might be connected to the same node. This means that each of the CVI modules with the valid signal high will sample the data and write it to the node 102. Therefore, multiple copies of the same data for the same trigger event appear in the V2C subnodes of the node 102. Without the association of threads 96, 97, 98, and 101 to specific V2C subnodes, the C models would process that same data multiple times, and get out of sequence.

Data written by a thread is addressed to only the corresponding CVI module, and data written by a CVI module is addressed to only its corresponding thread. Also, in cycles in which the C model is stable, but no data was written by the corresponding threads of the CVI modules, the corresponding status registers 106 associated with the GET calls of the CVI modules to be set low. The status registers 106 can therefore be used as tri-state enable signals in the CVI modules. The instance with the status register 106 set high causes the bus 91 to be driven for that clock cycle, and the other CVI modules (i.e., those with the status registers set low) will have their output drive enable signals 114 set low. The Verilog code for the CVI modules of the bi-directional block in this example might look as follows:

Module io_block (Clk_i, Data, Write, Full);
input Clk_i;
Data [7:0] Data;
inout Write, Full;
reg [7:0] data_reg;
reg valid_reg, st_reg, empty_reg, full_reg;
wire (strong1, pull0) Write, Full;
assign Data = valid_reg ? data_reg 8′bz;
assign Write = (valid_reg & ! Full);
wire NotFull = (St_reg & ! valid_reg);
wire data_put_en = (!valid_reg & Write);
initial begin

$gps_put_to_c(“Data”, data_put_en, “@(posedge Clk_i)”,
full_req, Data, st_reg);
$gps_get_fm_c(“Data”, NotFull, “@(posedge Clk_i)”,
empty_reg, data_reg, valid_reg);

end
endmodule

The nets shown as dotted lines represent a wired OR operation. Any CVI module that drives high the Write net 112 or the Full net 113, results in the net value being high. The net value is low only if none of the CVI modules are driving high. This can be accomplished in Verilog by using a wire for the Full and Write ports that drives strong 1 and resistive 0. In this case, the Full and Write ports must also be declared as I/O ports. The meaning of the Write signal 102 is that there is valid data on the bus 91 that should be written. If none of the CVI modules have valid data, then the bus 91 goes to high-Z and the Write signal will be low. The Full signal 113 goes high when any CVI module, other than the current writer, becomes full. This signal also forces the Write signal 112 low, and informs the writing CVI module that the next data written will not be received. The writing CVI module therefore knows not to attempt to write a new value on the next cycle.

### Controlling Action Event Concurrency

The manner in which event ordering is controlled in accordance with the present invention will now be described with reference to the example embodiments illustrated in FIGS. 5-8. FIG. 5 illustrates a linear statement list 114 of grouped Verilog statements and its corresponding tree-structured list 115 representing the grouping set forth in the linear list 114. These lists demonstrate the manner in which HDL (e.g., Verilog) constructs are used in accordance with the present invention to control event ordering in the CVI modules of the present invention. In the tree-structured list 115, the circles with “X”s in them represent fork join blocks and the circles with the “+”s in them represent begin-end blocks.

In the example shown in FIG. 5, circle 125 represents the beginning of a block of Verilog statements containing statements A and B, numbered 127 and 128, respectively. The circle 129 represents the first fork in the branch beginning at circle 125. This fork in the tree structure leads to the begin-end blocks represented by circles 131 and 132, which each contain two groups of statements E, F and C, D that correspond to groups of concurrent events (133, 134 and 135, 136). The circle 137 represents a fork-join block in the tree structure having a branch that contains statement G, a branch containing a block of statements beginning with H and ending with I and a branch containing a block of statements J, K and L. Circle 138 represents the begin-end block containing statements H (141), I (142) that are in a branch that is parallel with statement G (139). Circle 132 represents a begin-end block containing statements J (143), K (144) and L (145). This concludes the statements and blocks for the branch represented by circle 125.

In parallel with the branch that begins with circle 125 is the branch that begins with circle 124 and contains statement M (123). Circle 122 represents the first fork in the begin-end branch represented by circle 121 and leads to a branch containing statement N (120) and a branch containing statements O (119) and Q (118). The circle 117 represents the fork-join block enclosing the entire list, and containing statement P (116), which is in parallel with all of the other branches of the tree structure 115.

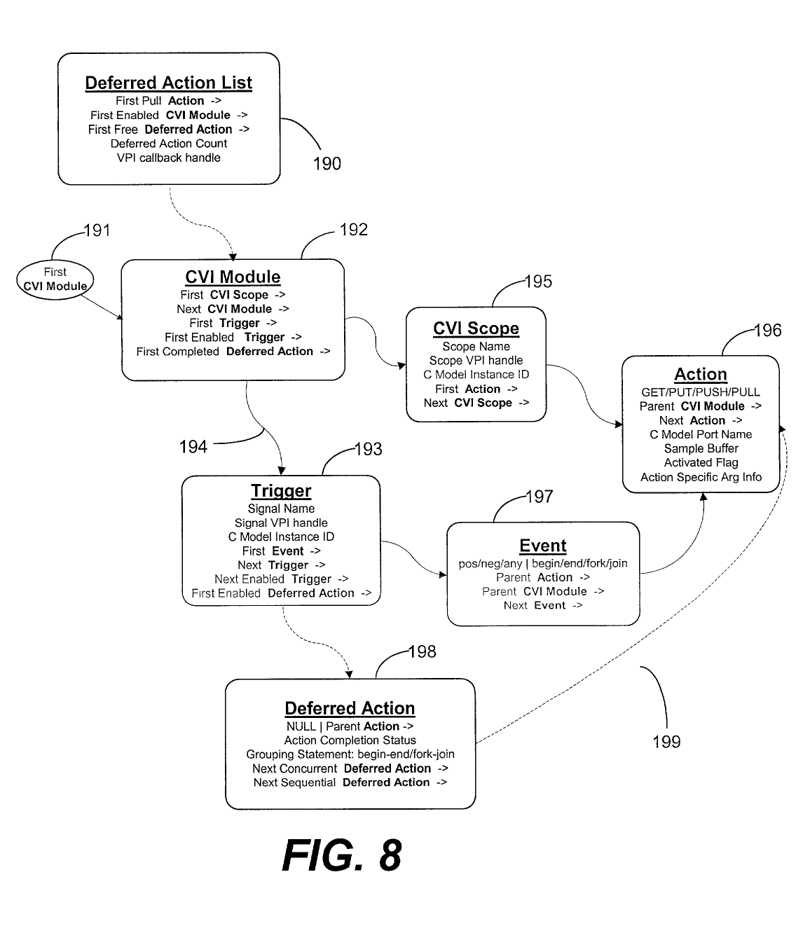

The concurrency of event ordering is readily apparent from the tree structure 115. In order for a CVI module to preserve proper Verilog-style event ordering specified from multiple initial blocks, or from fork-join and begin-end blocks, a CVI action database shown in FIG. 8 is structured to represent the Verilog blocks in the CVI module database object 192. The process of building the action list starts with the first CVI call for a given trigger occurrence in the CVI module. First, the CVI module statements are scanned to create the linear list of block grouping statements for the CVI module. This list is added to a Trigger object (193) by using an Event object (197) in blocking statement mode. The CVI edge-type Event objects (197) are then inserted into the list by counting how many block group statements must be traversed before the current action is reached. At the end of time zero in the simulation, after all the initial blocks have been processed, the list associated with each trigger is optimized to eliminate redundant blocking statements. This is done to improve performance, because the linear list will be used repeatedly as a template to build an enabled deferred action list. This optimization occurs at the C model invocation phase, which is represented by block 24 of FIG. 2.

When an action callback function is called as a trigger event occurs, the linear list is traversed with a recursive algorithm to build a tree structured list, such as tree structured list 115, which stores a deferred action list. The tree structured list that stores the deferred action list is designed in accordance with the present invention to be easily “pruned”, i.e., as actions are completed, they are moved to a completed deferred action list and the tree structured list is collapsed accordingly.

In FIG. 8, each of the objects in the CVI module data structure, in accordance with the preferred embodiment, are shown. Entries that are pointers to other objects are shown with the referenced object type in Bold followed by [symbol] . Fields shown with values separated by ‘/’ are enumerations of specific choices which specify the record type. For example the “Event” object 197 can be a ‘pos’, ‘neg’, or ‘any’ edge event, or a ‘begin’, ‘end’, ‘fork’ or “join’ blocking statement. Fields containing the ‘|’ character, as in the “Event” object 197, indicate that the object operates in distinct modes which may affect how other fields are used. The objects' primary relationships are shown with arrows 194. The object relations shown with solid-line arrows 194 indicate that the CVI module data structure relation is built once during the initialization phase of simulation (blocks 23 and 24 of FIG. 2). The building of the objects and relations represented by these blocks (192, 193, 195, 196, 197) corresponds to the static portions of the CVI module data structure objects. The object relationships shown with dashed-line arrows 156 indicate object relationships (blocks 190 to 192, 193 and 198) that are dynamically changing as the simulation runs.

The static portion of the CVI module data structure is built up as the simulator is processing the initial blocks in the Verilog CVI modules (block 23 in FIG. 2). As the CVI system tasks are called, the corresponding task finds the Verilog model and scope from which it was called, and inserts an Action object 196 that saves the argument information from the task. The Action object 196 includes an Action list that includes the port name and associated node pointer enable, status, and data argument handles, as well as the action type. The Trigger object 193 includes a Trigger list that holds names and handles for trigger signals appearing in the GET, PUT or PUSH calls of the instance, as well as a list of edge and block statement type Event objects 197 associated with the trigger signals. For the PUSH action, the trigger event is a value change of the signal itself. Each Event object 197 has a pointer to a GET or PUT action object 196 that should be processed when the event occurs. The Action list and the Trigger List are static during the simulation, but the enabled deferred action Ttigger list and the completed deferred action list contained in the Deferred Action List object 190 change as events are scheduled and processed during the simulation.

In order to improve performance, in accordance with the preferred embodiment of the present invention, the trigger event argument of the task is separated out into the Trigger object 193 and the Event object 197. This separation allows task calls within the same model that have the same trigger signal to share the same Trigger object, and thus only one callback is needed for each trigger signal in the model. The entry point for the static model database is a global variable, represented by block 191, references the first CVI Module object 192 on the list. The Deferred Action List object 190 is the entry point for the dynamically changing portion of the action database. As trigger events occur, Deferred Action objects 198 are moved from a free list (referenced from the “First Free Deferred Action” field of object 190), and are placed on either the enabled or completed deferred action lists contained in the Deferred Action List object 190. The type field in the Event object 197 can be set to a begin/end/fork/join blocking statement. These types correspond to Verilog grouping statements. These grouping Event objects act as templates to define the sequence order for the processing of events on the Deferred Action List object 190. The grouping Event object 197 results in a corresponding grouping statement in the Deferred Action object 198 when the event list for Trigger object 193 is processed.

The deferred action list entries are added to the Deferred Action List object 190 as action events occur, and are removed as they are completed by iterations of the C model, as described above with reference to FIG. 5. An instance in the CVI Module object 192 may contain multiple CVI scope objects 195. The first scope always corresponds to the CVI module. Other scopes are created when named Verilog begin-end or fork-join blocks are defined. It is the scope path from which a CVI task is called that is matched against the C model instance path during the intialization phase described in FIG. 2. Verilog named begin-end blocks can therefore be used to define additional hierarchy levels in order to create a correspondence with the C model.

The tree structured list of the present invention is built with Deferred Action objects using a “next concurrent” pointer and a “next sequential” pointer, which are shown on object 198 of FIG. 8. Processing the events in accordance with the order in which they are listed on a given execution branch structure ensures that only actions on the same branch are capable of blocking actions later on that same branch. The CVI module writer can therefore completely control the event ordering and grouping of CVI actions by using standard Verilog grouping statement blocks in the manner indicated in FIG. 5.

### Dual Channel CVI Module Example

The following is an example illustrating how Verilog grouping statements are used to control the execution order of CVI tasks. Concurrent branches of execution are needed when a block contains multiple independent data flows. The aforementioned GET and PUT tasks are processed in the order in which they appear in the CVI module. This means that an earlier task that is blocked also prevents completion of tasks that follow it. With regard to a block in which two data paths operate independently, if one of the channels is blocked, the other channel should not be prevented from continuing. In accordance with the present invention, this is accomplished by placing the GET and PUT tasks for each channel into separate concurrent execution blocks using the Verilog fork-join construct in the manner demonstrated by the example of FIG. 5, or by placing the statements in separate initial blocks.

Module dual_channel_block (Clk_i, DataA_i, DataB_i,

DataA_o, DataB_o, En_A, En_B, Valid_A, Valid_B);

input Clk_i;
input [7:0] DataA_i, DataB_i;
output [7:0] DataA_o, DataB_o;
output Valid_A, Valid_B;
reg [7:0] DataA_o, DataB_o;
reg st_A, st_B, Valid_A, Valid_B;
initial begin

fork

begin

$gps_put_to_c(“DataA_i”, En_A, “@(posedge Clk_i)”,

0, DataA_i, st_A);

$gps_get_fm_c(“DataA_o”, 1, “@(posedge Clk_i)”,

0, DataA_o, Valid_A);

end
begin

$gps_put_to_c(“DataB_i”, En_B, “@(posedge Clk_i)”,

0, DataB_i, st_B);

$gps_get_fm_c(“DataB_o”, 1, “@(posedge Clk_i)”,

0, DataB_o, Valid_B);

end

join

end
endmodule

The Verilog event ordering of the GET and PUT calls in the initial block doesn't directly control the processing of actions during the simulation, since these tasks are only called once at the start of the simulation. In accordance with the present invention, the processing order of GET and PUT tasks during simulation is actually controlled by saving the grouping statement information along with the GET and PUT action objects in the action list database of FIG. 8. The grouping statement information in the action event list serves as a template when adding deferred actions to the deferred action list. The deferred action list is tree structured such that concurrent tasks are on separate branches of the tree.

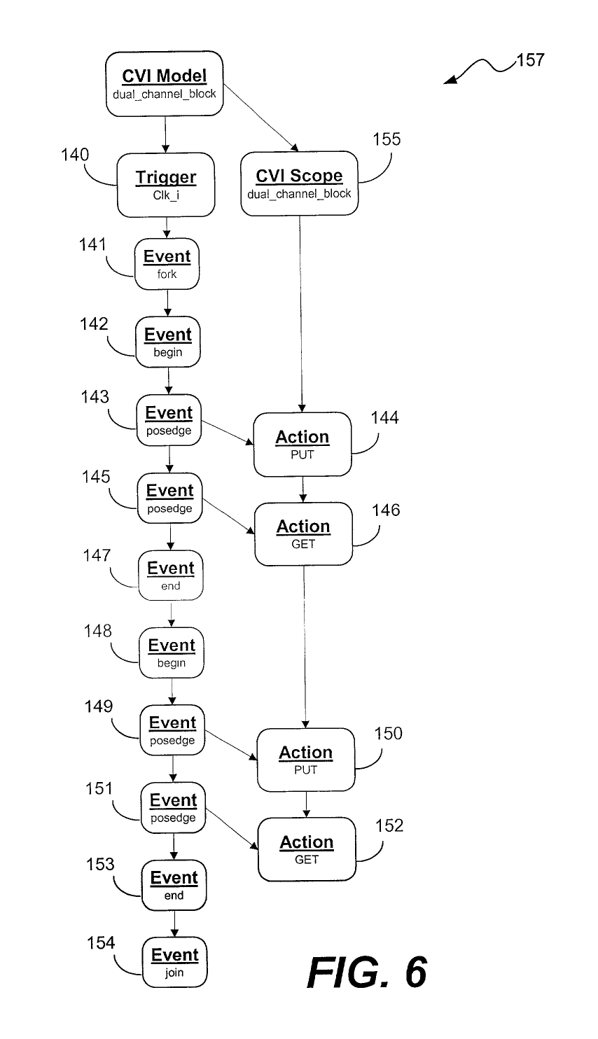

With reference to FIG. 6, an action list 157 starting with the CVI Model object created at the beginning of the simulation (i.e., during initialization in block 23 and 24 of FIG. 2) for a dual channel block example is shown. It should be noted that the blocking statements are stored in linear fashion. The fork and join statements are represented in the Event objects 141 and 154, respectively. The begin and end statements are represented in sequential order as blocks 142, 147, 148, and 153. The PUT and GET statements are represented in the Event objects 143, 145, 149 and 151, and in the corresponding Action objects 144, 146, 150 and 152.

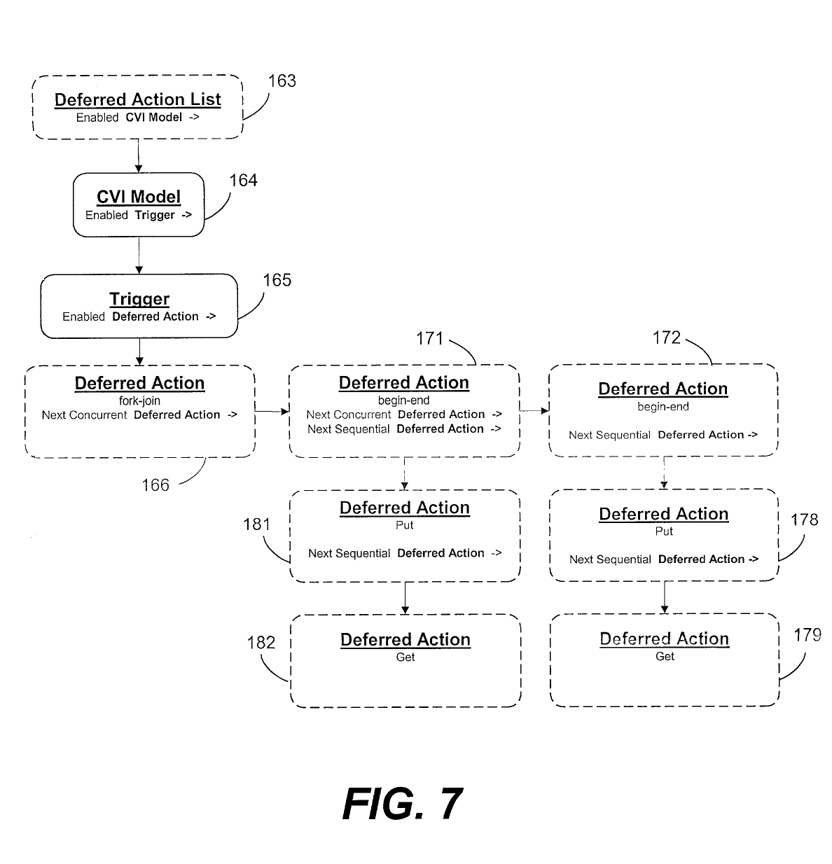

With reference to FIG. 7, when a signal change occurs on Clk_i, which corresponds to the Trigger object 165, an “Action Callback” procedure scans the Event objects 141, 142, 143, 145, 147, 148, 149, 151, 153 and 154 referenced by the Trigger object 140. The “Action Callback” procedure then maps the events into a corresponding tree structured list of Deferred Action objects shown in FIG. 7, and which are accessed through the Deferred Action List object 163 which contains actions to be processed for the current simulation time The CVI Model object 164 corresponds to the CVI Model object in FIG. 6. The fork and join Event objects 141 and 154 map to the Deferred Action object 166 shown in FIG. 7. The begin and end Event objects 142 and 147 map to the Deferred Action object 172 shown in FIG. 7. The begin and end Event objects 148 and 153 map to the Deferred Action object 171 shown in FIG. 7. The Event objects 143, 145, 149 and 151 map to the Deferred Action objects 178, 179, 181 and 182, respectively. The vertical branches on the tree structure of FIG. 7 are processed such that they do not block each other.

Therefore, it can be seen from the description provided herein that HDL (e.g., Verilog) constructs can be used to easily control event ordering for events to be processed during a mixed-language simulation. As events occur during simulation, the events are mapped to an HDL tree structured list of deferred action objects to enable concurrent execution of actions in parallel branches of execution. Furthermore, by “pruning” the tree structured list in the manner discussed above, simulation performance is optimized. Also, by allowing all event processing to be controlled through the use of HDL constructs, the designer's task of controlling event ordering is simplified considerably.

It should be noted that the present invention has been described with respect to one particular implementation, which corresponds to the preferred embodiment of the present invention. However, as will be understood by those skilled in the art that, in view of the description provided herein, the present invention can be implemented in a number of ways to achieve the goals of the present invention, i.e., utilizing mixed-language models in a simulator to test and model hardware designs. Therefore, those skilled in the art will understand that modifications can be made to the implementation discussed above, and that all such modifications are within the scope of the present invention.

What is claimed is:

1. An apparatus for controlling event ordering in a mixed-language simulator, the mixed-language simulator utilizing at least one model written in a source code language and at least one model written in a hardware description language (HDL), the apparatus comprising:
logic configured to generate a list of actions to be performed for each occurrence of a trigger event, the list of actions for each trigger event being mapped by said logic into a list of objects, the objects being listed in an order that is consistent with an order in which associated HDL objects are listed, and wherein the ordering of the HDL objects in the list controls an order of event processing of all source code model interface tasks.

2. The apparatus of claim 1, wherein the list of objects is configured by said logic to allow objects associated with trigger events corresponding to concurrent times to be executed concurrently during simulation.

3. The apparatus of claim 1, wherein the list of objects is a tree structured list having branches of execution, and wherein at least two branches of execution are in parallel with each other, and wherein objects associated with trigger events that correspond to concurrent times are comprised in parallel branches of execution in the tree structured list.

4. The apparatus of claim 1, wherein the list of objects is a linear list and wherein the objects comprise block grouping statements and at least first and second event objects each comprising executable statements that are configured within the linear list by said logic to be executed in parallel, said first and second objects being associated with events corresponding to concurrent times.

5. The apparatus of claim 4, wherein the linear list is traversed by said logic to identify objects corresponding to enabled deferred actions and objects corresponding to non-enabled deferred actions, and wherein said logic removes anyobjects corresponding to non-enabled deferred actions from the list.

6. The apparatus of claim 3, wherein the tree structured list is traversed by said logic to identify objects corresponding to enabled deferred actions and objects corresponding to non-enabled deferred actions, and wherein said logic removes any objects corresponding to non-enabled deferred actions from the tree structured list.

7. The apparatus of claim 1, wherein when a trigger event occurs, an action callback function is called by said logic, and wherein said logic executes the action callback function to traverse the list of objects in accordance with a recursive algorithm to transform the list of objects into a tree structured list that comprises a list of enabled deferred action objects and a list of non-enabled deferred action objects, and wherein said logic removes any non-enabled deferred action objects from the tree structured list in order to optimize simulator performance.

8. The apparatus of claim 3, wherein said logic builds the tree structured list of objects using a “next concurrent” pointer and a “next sequential” pointer to ensure that objects comprised in the tree structured list are processed in a proper order and to ensure that only actions of objects that are listed on a same branch of execution are capable of blocking actions of objects that are listed in subsequent order on said same branch of execution.

9. A method for controlling event ordering in a mixed-language simulator, the mixed-language simulator utilizing at least one model written in a source code language and at least one model written in a hardware description language (HDL), the method comprising:
generate a list of actions to be performed for each occurrence of a trigger event;
mapping the list of actions for each trigger event into a list of objects that are listed in an order that is consistent with an order in which trigger events occur, and wherein the ordering of the objects in the list controls an order of event processing of all source code model interface tasks.

10. The method of claim 9, wherein the list of objects is configured to allow objects associated with trigger events corresponding to concurrent times to be executed concurrently during simulation.

11. The method of claim 9, wherein the list of objects is a tree structured list having branches of execution, and wherein at least two branches of execution are in parallel with each other, and wherein objects associated with trigger events that correspond to concurrent times are comprised in parallel branches of execution in the tree structured list.

12. The method of claim 9, wherein the list of objects is a linear list and wherein the objects comprise block grouping statements and at least first and second event objects each comprising executable statements that are configured within the linear list by said logic to be executed in parallel, said first and second event objects being associated with events corresponding to concurrent times.

13. The method of claim 12, further comprising the steps of:
traversing the linear list and identifying objects that correspond to enabled deferred actions and objects that correspond to non-enabled deferred actions; and
removing any objects from the linear list that correspond to non-enabled deferred actions to thereby optimize performance of the simulator.

14. The method of claim 11, further comprising the steps of:
traversing the tree structured list and identifying objects in the tree structured list that correspond to enabled deferred actions and objects corresponding to non-enabled deferred actions; and
removing any objects from the tree structured list that correspond to non-enabled deferred actions.

15. The method of claim 11, wherein the tree structured list of objects includes a “next concurrent” pointer and a “next sequential” pointer that ensures that objects comprised in the tree structured list are processed in a proper order and that ensures that only actions of objects that are listed on a same branch of execution are capable of blocking actions of objects that are listed in subsequent order on said same branch of execution.

16. A computer program for controlling ordering of event processing in a mixed-language simulator, the mixed-language simulator utilizing at least one model written in a source code language and at least one model written in a hardware description language (HDL), the computer program being embodied on a computer readable medium, the computer program comprising:
a first code segment, the first code segment generating a list of actions to be performed for each occurrence of a trigger event;
a second code segment, the second code segment mapping the list of actions for each trigger event into a list of objects that are listed in an order that is consistent with an order in which trigger events occur, and wherein the ordering of the objects in the list controls an order of event processing of all source code model interface tasks.

17. The computer program of claim 16, wherein the list of objects is configured to allow objects associated with trigger events corresponding to concurrent times to be executed concurrently during simulation.

18. The computer program of claim 16, wherein the list of objects is a tree structured list having branches of execution, and wherein at least two branches of execution are in parallel with each other, and wherein objects associated with events that correspond to concurrent times are comprised in parallel branches of execution in the tree structured list.

19. The computer program of claim 16, wherein the list of HDL objects is a linear list and wherein the HDL objects comprise block grouping statements and at least first and second HDL objects each comprising executable statements that are configured within the linear list by said logic to be executed in parallel, said first and second HDL objects being associated with events corresponding to concurrent times.

20. The computer program of claim 17, further comprising:
a third code segment, the third code segment traversing the list of HDL objects and identifying listed HDL objects that correspond to enabled deferred actions and HDL objects that correspond to non-enabled deferred actions; and
a fourth code segment, the fourth code segment removing any HDL objects from the list of HDL objects that correspond to non-enabled deferred actions to thereby optimize performance of the simulator.
